(19) United States
(12) Patent Application Publication
(10) Pub. No.: US 2018/0222536 A1
(43) Pub. Date: Aug. 9, 2018

(54) MOTOR VEHICLE COMPONENT MADE OF TRIPLE-LAYER LAMINATED STEEL

(71) Applicant: Benteler Automobiltechnik GmbH, Paderborn (DE)

(72) Inventors: Andreas FREHN, Delbrueck (DE); Georg FROST, Steinheim (DE); Christian HANDING, Langenberg (DE); Christoph NITSCHKE, Bad Lippspringe (DE); Martin POHL, Altenbeken (DE)

(21) Appl. No.: 15/748,048

(22) PCT Filed: May 12, 2016
(86) PCT No.: PCT/DE2016/100224

§ 371 Date: Jan. 26, 2018

(30) Foreign Application Priority Data
Jul. 28, 2015 (DE) 10 2015 112 327.4

(51) Int. Cl. B62D 29/00; B21D 53/88; B21D 35/00; B21D 22/02; B32B 15/01

(52) U.S. Cl. CPC B62D 29/007; B21D 53/88; C21D 9/46; B21D 22/022; B32B 15/011; B21D 35/007

(57) ABSTRACT

A motor vehicle component is disclosed. The component is manufactured by hot forming die quenching a sheet metal blank made of a hardenable steel alloy, and the motor vehicle component is made of a triple-layer laminated steel and including a central layer of hardenable steel ally, and the outer layers of a stainless steel alloy.

### RELATED APPLICATIONS

The present application is a National Phase of International Application Number PCT/DE2016/100224 filed May 12, 2016 and is related to and claims priority benefits from German Application No. 10 2015 112 327.4 filed on Jul. 28, 2015.

### BACKGROUND

### 1. Field of the Invention

The disclosure is related to a motor vehicle component and, more specifically, to a motor vehicle component manufactured by hot forming and die quenching a metallic blank.

### 2. Description of the Related Art

In the prior art, there is a known practice of manufacturing components for motor vehicles by forming sheet metal blanks. For example, it is possible in this way to manufacture structural vehicle components in the form of longitudinal members, crossmembers and motor vehicle pillars but also external skin components of motor vehicles. It is also possible to manufacture attached components for motor vehicles, e.g. crossmembers, crash boxes or similar components.

The components are generally formed from steel sheets or, alternatively, from light metal sheets, e.g. aluminum sheets. When manufacturing steel components, hot forming and die quenching technology has furthermore become popular precisely in motor vehicle production. For this purpose, hardenable steel alloys are used, e.g. 22MnB5 steel.

For this purpose, the sheet metal blanks supplied are first of all heated in the direct hot forming process to above the austenitization temperature, that is to say above the AC3 temperature. This is generally more than 900° C. In this hot state, there is greater freedom as regards shaping, and the sheet metal blank, which is above the AC3 temperature, is hot-formed. It is then cooled so rapidly in the forming die that hardening occurs. In particular, the austenitic material microstructure is converted to a martensitic material microstructure.

In an indirect hot forming process, the blank composed of a hardenable steel alloy is first of all formed in the cold state at room temperature. The motor vehicle component produced by forming is then heated to above the austenitization temperature and is cooled with such rapidity in a holding die that hardening of the material microstructure occurs in this case too.

It is possible to produce motor vehicle components with high- or extremely high-strength material properties. However, the disadvantage is that the motor vehicle components produced are susceptible to corrosion. Known protective measures are the application of a coating, e.g. by means of the cathodic dip coating method. The processing of metallically precoated blanks is also known, an intermetallic phase being formed between the precoating and the hardenable steel alloy underneath the precoating under the action of heat.

### SUMMARY

According to one exemplary embodiment, a motor vehicle component which exhibits high degrees of forming is provided having specifically desired strength properties and has improved behavior in relation to stone chips and corrosion.

The motor vehicle component according to the invention is produced by hot forming and die quenching a metallic blank made of a hardenable steel alloy. It is characterized in that the metallic blank is made of a triple-layer laminated steel, also referred to as a sheet assembly. A central layer, also referred to as a center layer, is made of a hardenable steel alloy. The two external layers are made of a stainless steel alloy, in particular a high-grade stainless steel alloy. Thus, the motor vehicle component is manufactured from a triple-layer laminated steel and, by virtue of the central layer, has the desired partial or homogeneous strength properties which can be achieved with a hardenable steel alloy. The requirements in respect of corrosion resistance and resistance to stone chips are met by the external layers made of a stainless steel alloy. In particular, the individual layers of the triple-layer laminated steel are sheet-like and preferably joined together materially. For example, they can be manufactured by roll-bonded cladding from multi-layer blocks, slabs and billets, in particular under the action of heat.

In comparison with anticorrosion measures known from the prior art, there is, according to the invention, no need initially for further processing after the hot forming and die quenching. The external layers provide corrosion protection. Upon conclusion of the die quenching process, the specifically desired strength properties have been established. However, partial thermal aftertreatment can take place within the scope of the invention in order, for example, to re-soften already hardened regions in the motor vehicle component.

It is thus possible to obtain a tensile strength Rm greater than 1200 MPa, in particular greater than 1300 MPa, in the central layer of the motor vehicle component. When using high-carbon heat-treatable steel alloys, it is possible to achieve tensile strengths Rm greater than 1700 MPa, in particular greater than 1500 MPa, preferably greater than 1900 MPa. A yield stress greater than 1200 MPa is preferably set. An Rp 0.2 proof stress greater than 900 MPa, in particular greater than 1000 MPa, can be set.

Thus, according to the invention, the motor vehicle component can be designed as a rocker panel, as a crossmember, as a door impact beam, as a doorframe of a side wall, as a tunnel, as a longitudinal member, as a bulkhead, as a floor panel or floor panel sheet or as a motor vehicle pillar. Other components of a motor vehicle body or even motor vehicle safety components can likewise be taken to be motor vehicle components in the sense according to the present invention or can be manufactured from the triple-layer laminated steel.

The motor vehicle component according to the invention is furthermore characterized in that it is manufactured, in particular, as an elongate component, e.g. as a crossmember, door impact beam, longitudinal member or even a rocker panel. In this case, the motor vehicle component is preferably designed, at least in some section or sections, as a closed hollow profile in cross section.

The closed hollow profile can be manufactured in three ways within the scope of the invention. Within the scope of the invention, the hollow profile can be formed in one piece and with a unitary material. In this case, the metallic blank is processed by U-O forming. The closed cross section can then furthermore be permanently coupled together by means of a coupling process applied at the end or on a flange. In particular, it is then furthermore possible within the scope of the invention to process the hollow profile by hydroforming. In this way, different cross-sectional shapes in the longitudinal direction that are appropriate to the load can be produced. Within the scope of the invention, U-O forming and/or hydroforming can be carried out as the hot forming and die quenching processes. Similarly to the U-O forming of sheet metal blanks, another possible option is that of roll forming triple-layer laminated steel in the form of strips. In this process, the laminated steel is formed into a hollow profile by a series of rolls. Here, the rolls perform the function of two press dies in the U-O forming process.

Another possibility for the production of a hollow profile with a closed cross section is the use of a closing plate. In this case, the closing plate itself can also be manufactured from the triple-layer laminated steel. However, it is also possible for the closing plate to be made of a single-layer steel sheet, in particular of the material of the central layer of the triple-layer laminated steel. Coupling is achieved by material bonding, in particular welding, preferably by spot welding.

In particular, it is possible, after the manufacturing process and in the case of coupling to another component, e.g. a closing plate, for the entire motor vehicle component to be subjected after the joining process to a further anticorrosion measure, e.g. cathodic dip coating. However, the component preferably has no additional corrosion coating on the external layers before it is installed in the vehicle in accordance with the intended purpose.

In another advantageous variant embodiment of the present invention, the blank itself is manufactured as a tailored rolled blank, tailored formed blank or as a tailored welded blank, with the result that the motor vehicle component has different wall thicknesses and/or different material properties, in particular strength properties, in different regions. Thus, particularly in the case of a tailored rolled blank, different wall thicknesses can be produced in different regions. The motor vehicle component produced from the tailored rolled blank then also has the different wall thickness in different regions. An optimum in terms of usage of material and required strength properties is thereby provided.

In the case of a tailored welded blank, a blank is first of all welded together from different blanks with different wall thicknesses and/or strength properties. This blank produced as a tailored welded blank can then be produced from individual component blanks, which are all made of a triple-layer laminated steel. However, it is also possible for at least one component blank to be produced from a single-layer steel, in particular also from a hardenable steel.

It is also possible to use tailored formed blanks. In this case, blanks are thinned, e.g. locally by forming, e.g. deep drawing.

In another advantageous variant embodiment of the present invention, the external layers have different wall thicknesses from one another. The central layer preferably has a thickness which is less than or equal to 90% of the total thickness. Consequently, both external layers preferably have a thickness which is greater than or equal to 5% of the total thickness. The total thickness is preferably from 1 mm to 10 mm, in particular 1.5 mm to 5 mm. Within the scope of the invention, however, it is conceivable for the external layers to have different thicknesses from one another. At the least, however, an external layer should have a minimum thickness of 0.1 mm. In the installed position of the motor vehicle component, an external layer facing in the direction of the road surface and/or environment should then have a greater wall thickness or thickness than the other external layer facing in the direction of a passenger compartment or the motor vehicle. This increases resistance to stone chips, in particular. An impinging stone, which, in particular, makes contact with high intensity, thus does not pierce the relatively thick external layer.

The terms wall thickness and thickness are used synonymously. The terms blank and sheet metal blank are also used synonymously.

The motor vehicle component can furthermore have at least one region of lower strength. This is produced by partial hot forming and die quenching, for example. The region of lower strength is either not austenitized and/or not cooled so rapidly, with the result that hardening does not take place. Thermal after-treatment can also preferably be carried out. As a result, components with improved corrosion protection or selectively sharply defined, mutually different strength regions can be manufactured. A component with such differential properties can also be provided by means of tailored welded blanks.

A motor vehicle component according to the invention can also furthermore preferably have one or more of the properties described below. In particular, it is manufactured by means of a method described below.

A motor vehicle component with improved crash performance is proposed, comprising at least one surface section comprising a multi-layer, in particular triple-layer, sheet assembly having a center layer and two external layers bounding the center layer on the outside. According to the invention, the external layers are connected over an extensive area and materially to the center layer. The characteristic here is that the external layers are composed of a rust-resistant steel alloy with a microstructure selected from the group comprising ferritic, austenitic or martensitic microstructures and the center layer is composed of a heat-treatable, in particular hardened, steel alloy, and the motor vehicle component has a bending angle greater than 80 degrees (°), determined in the plate bending test according to VDA 238-100:2010 with an Rp 0.2 proof stress greater than 900 MPa. This allows a maximum of corrosion protection over the entire life of the vehicle, even taking into account harsh processing and operating conditions. Furthermore, the external layer, which is connected firmly to the harder center layer and is softer, has the effect that the tendency for cracking during an envisaged load in a crash as well as during a joining or cold forming process following component shaping falls significantly. According to the invention, the external layers and the center layer are connected over an extensive area by material bonding in such a way that there are essentially no inclusions or impurities between the layers, wherein, in particular, a metallurgical joint is formed. According to the invention, the individual layers are preferably connected to one another materially and metallurgically over the full area. Here, the starting material used for the invention can, for example, be produced by hot rolling three connected slabs prefixed in advance mechanically and/or materially, or by hot rolling a slab cast in multiple stages or by hot rolling a deposit-welded slab.

As a ferritic rust-resistant steel alloy, it has been found particularly advantageous to use an alloy which, apart from impurities entailed by the melting process and iron, comprises the following alloy components in percent by weight:

carbon (C): 0.08% to 0.16%
silicon (Si): 0.5% to 1.8%
manganese (Mn): 0.8% to 1.4%
chromium (Cr): 13.0% to 22.0%
aluminum (Al): 0.5% to 1.5%
phosphorus (P): 0.06% maximum
sulfur (S): 0.02% maximum.

While chromium ensures heat resistance and thus a scale-free surface during heating and hot forming, the heat-treatable steel alloy of the center layer ensures a maximum of tensile strength. As regards other ferritic rust-resistant steel alloys that can be used, attention may furthermore be drawn here to the content of EN 10088-1, with chromium contents of from 10.5 to 30%, depending on the grade. To ensure weldability, use is made of stabilizing additives of less than 0.5% of titanium, niobium or zirconium and of a carbon content limited to 0.16%.

Concerning the use of austenitic rust-resistant steel alloys, attention is drawn here to grades EN 1.4310 and EN 1.4318. The ductility and elongation at break of rust-resistant austenitic steels is very high both in the low temperature range and during hot forming. The susceptibility to brittle fracture is extremely low. During cold forming and during a crash, its strength is increased by the conversion of metastable austenitic phases into martensite.

Concerning martensitic rust-resistant steel alloys, attention may be drawn, by way of example, to the easily weldable grades EN 1.4313 and EN 1.4418 and to supermartensitic steels of grade EN 1.4415. The latter are simultaneously of high strength and very tough and, apart from impurities entailed by the melting process and iron, have a chemical composition, expressed in percent by weight, as follows:

| carbon (C) | 0.03% maximum |
|---|---|
| chromium (Cr) | 11-13% |
| nickel (Ni) | 2-6% |
| molybdenum (Mo) | 3% maximum |
| nitrogen (N) | >0.005%. |

The bending angle of the motor vehicle component is preferably greater than 95°, and the Rp0.2% proof stress is greater than 950 megapascals (MPa).

Moreover, the bending angle is greater than 90°, in particular greater than 100°, preferably greater than 110°. In particular, the motor vehicle component has a product of the bending angle and the Rp0.2 proof stress of between 90,000° MPa (degrees megapascals) and 180,000° MPa, whereby optimum behavior of components in crashes is obtained without special process control measures during or after hot forming, without the risk of cracks or even component failure.

To make maximum use of the potential of the heat-treatable steel alloy for lightweight construction, the center layer of the surface section preferably has an ultra-high-strength microstructure according to the invention, with at least 80 percent martensite. In this case, the tensile strength Rm within the surface section comprising triple-layer laminated sheet metal is greater than 1300 megapascals (MPa).

It is furthermore possible for the center layer of a surface section to have a microstructure selected from a group comprising tempered martensite, which makes up at least 80 percent, or a hybrid microstructure comprising at least 70 percent ferrite and perlite, with the remainder being martensite, residual austenite and/or bainite.

The percentage Figures for the constituents of the microstructure relate to area percentages that can be easily determined by metallographic methods.

The surface section comprising the triple-layer laminated metal sheet preferably has a total thickness and one of the external layers has a thickness, wherein the thickness of one of the external layers corresponds to at least 3 percent and at most 15 percent, preferably 4 percent to 10 percent, of the total thickness of this surface section. Here, total thickness should be taken to mean the sum of the thicknesses of the two external layers and of the center layer in the respective surface sections. The total thickness is preferably between 1 and 10 millimeters (mm), in particular between 1.7 and 3.5 mm. A thicker external layer provides hardly any further advantages in terms of corrosion protection but significantly reduces the overall strength of the surface section. Currently, a thinner external layer can be produced only with difficulty in a reliable process by rolling and, given a conventional service life of a motor vehicle, can furthermore not be reduced in view of corrosion protection. Within the scope of the invention, the mutually opposite external layers preferably have the same thickness. However, it is also possible for external layers of different thickness to be formed in at least one surface section, if this is necessary, to ensure that, in the case of a hollow motor vehicle component for example, the component is particularly well adapted to different crash or corrosion requirements on the inside and the outside.

Particularly suitable as a heat-treatable steel alloy is a manganese-boron steel such as 16MnB5, but preferably 22MnB5 or, alternatively, 36MnB5. In particular, heat-treatable steel alloys with a carbon content greater than or equal to 0.27% by weight can be used, e.g. MBW 1900. These would be too brittle for direct hot forming and die quenching. By virtue of the external layers, it is possible to process them by means of hot forming and die quenching. It is also possible to employ carbon contents greater than 0.30%, in particular greater than 0.35%.

FIG. 13 shows a diagram for the mechanical characteristics of tensile strength Rm, Rp0.2 proof stress and elongation at break A30, and FIG. 14 shows a diagram for the bending angle of a body component according to the invention comprising a center layer of steel of grade 22MnB5 and two external layers, each with a thickness of 5 percent of the total thickness and composed of a ferritic rust-resistant steel alloy. Here, X10CrAlSi18 was used as the ferritic steel alloy.

In comparison with this, FIGS. 15 and 16 show diagrams for the results for a component made of steel with the commercial name Usibor with an aluminum-silicon coating on both sides in accordance with the prior art. All the components had a thickness of 2 millimeters.

In an improved development of the invention, the motor vehicle component has a second surface section made of a triple-layer laminated metal sheet. Here, the first surface section has a first center layer having an ultra-high-strength microstructure containing at least 80 percent of martensite, while the second surface section has a second center layer with a microstructure selected from a group comprising at least 80 percent of tempered martensite or a hybrid microstructure containing at least 70 percent of ferrite and perlite and residual percentages of martensite and/or residual austenite and/or bainite. In this way, it is possible to produce components with softer and more ductile surface sections.

It is furthermore possible to envisage that the second surface section is a triple-layer laminated metal sheet and the first center layer and the second center layer each have a thickness, and the thickness of the first center layer differs from the thickness of the second center layer. In this way, a particularly thick surface section can be arranged in zones of extremely high stress and load bearing capacity or where material reinforcement within a thinner surface section is required for joining by means of a rivet or screw, for example.

In this case, the first surface section can have a total thickness which differs from the total thickness of the second or further surface sections by at least 10 percent, in particular between 20 and 100 percent.

According to one exemplary embodiment, it is also possible to envisage that the motor vehicle component has a second surface section or further surface sections made of a ferritic or martensitic or austenitic rust-resistant steel alloy. In particular, the surface sections of the motor vehicle component can adjoin one another and can be butt welded.

However, it is also possible for the motor vehicle component to have a second surface section made of a ferritic steel alloy, in particular the surface sections once again being butt welded to one another.

It is also possible for the second surface section or further surface section to be selected from a low-alloy steel or a multiphase steel alloy or from a steel alloy with TWIP and/or TRIP properties. Preferably, the second surface section can be heated only to a temperature less than the AC 1 temperature during the process for the manufacture of the running gear or body component in order to prevent scaling.

The motor vehicle component preferably has a rim, wherein, at least in some section or sections, the rim is surrounded at one end, in the surface section with the triple-layer laminated metal sheet, by the external layer, such that the end of the center layer is screened from the environment by the external layer. This further improves corrosion resistance.

The methodological part of the invention is achieved by a method for manufacturing a motor vehicle component of the kind described above, comprising the following steps:

supplying a sheet metal blank comprising at least one surface section made of a triple-layer laminated metal sheet having a center layer made of a heat-treatable steel alloy and respective external layers bounding the center layer,
heating at least the laminated metal sheet, in particular the entire blank to the austenitization temperature,
hot forming the sheet metal blank in a press forming die cooled at least in some region or regions, and
at least partial hardening of the formed sheet metal blank in the press forming die or in a subsequent cooling die stage.

In the method, a particular advantage is obtained if the hot forming and hardening of the sheet metal blank is carried out in or by means of a single press having a plurality of die stages. As an alternative or preferably at the same time, provision can be made for the heating and hot forming of the sheet metal blank to be carried out in a single press having a plurality of die stages. Thus, at least one sheet metal blank is in each case simultaneously heated, hot-formed and hardened in a single press stroke. It is self-evident that an extremely short cycle time and hence high throughput can be made possible when using servo-motor-operated or mechanical presses.

In a development of the method according to the invention, the heating is carried out within 30 seconds, preferably within 20 seconds, in particular within 10 seconds, allowing space-saving austenitization with little loss of heat. It is advantageous if heating is carried out sequentially in synchronism with the hot forming or the press cycle of a hot forming line. As a further preference, heating can comprise at least one holding phase. Heating can be carried out without a protective gas atmosphere since the external layers do not have any tendency for scaling. As an advantage, there is the fact that blast cleaning of the fully formed component before painting or cathodic dip coating can be omitted.

In the heating of the sheet metal blank, contact heating can be used to particular advantage since it is associated not only with high efficiency and low heat losses but also with the possibility of adjusting a first surface section of the sheet metal blank to more than the austenitization temperature and a second surface section to less than 700° C. before hot forming by means of contact plates adjusted to different temperatures. This also applies to a temperature adjustment stage after heating and ahead of the press forming die stage. In particular, there is the advantage over precoated steels that there is no need for full alloying beforehand.

According to one exemplary embodiment, provision can be made here for component trimming or cutting, in particular piercing of the component, to take place after hot forming and die quenching and consequently only on the hardened component. This can then be accomplished by combined rolling and cutting or pressure cutting, in particular in a press die stage following the press forming die stage but also outside in a separate operation. In this case, part of the external layer is displaced in the rim region into the face of the separation region or hole rim and, at the same time, a slug or trimmed edge is removed. According to the invention, in contrast to the aluminum-clad heat-treated steel, the center layer is protected from environmental influences, in particular the introduction of process-related molecular hydrogen, during heating by the external layers made of rust-resistant steel alloy, and the risk of embrittlement of the component caused by the introduction of hydrogen is prevented. The high-grade steel external layers are not susceptible to cracking or fracture, in contrast to coated components. It is therefore very readily possible to cut them in the cold and hard state after die quenching. Particularly in the case of pressure cutting, the lower layer does not have any significant proportion of cracks. The cut edges are substantially free from burrs owing to the increase in ductility of the external layers. Trimming can also be carried out in a separate cutting tool. In particular, trimming is carried out in full.

This means to the final shape. In particular, a crack-free surface is provided. Moreover, the cut edge is provided very largely without cracks. There are preferably no cracks or microcracks larger than 10 μm at the surfaces. Thus, laser trimming or, alternatively, complex hot cutting can be eliminated.

### BRIEF DESCRIPTION OF THE DRAWINGS

For an understanding of embodiments of the disclosure, reference is now made to the following description taken in conjunction with the accompanying drawings, in which:

FIG. 1 is a cross-sectional view through a triple-layer laminated steel in accordance with one exemplary embodiment;

FIG. 2 is a cross-sectional view of the triple-layer laminated steel in accordance with another exemplary embodiment;

FIGS. 3a to 3e illustrate a crossmember manufactured in accordance with one exemplary embodiment;

FIGS. 4a to 4d illustrate a crossmember manufactured in accordance with one exemplary embodiment having a closing plate;

FIGS. 5a to 5f illustrate a door impact beam manufactured in accordance with one exemplary embodiment;

FIGS. 6a to 6f illustrate a sill manufactured in accordance with one exemplary embodiment;

FIGS. 7a to 7e illustrate an upper longitudinal member manufactured in accordance with one exemplary embodiment;

FIGS. 8a to 8c illustrate a lower longitudinal member manufactured in accordance with one exemplary embodiment;

FIGS. 9a to 9c illustrate a tunnel manufactured in accordance with one exemplary embodiment;

FIG. 10 illustrates a bulkhead manufactured in accordance with one exemplary embodiment;

FIG. 11 illustrates a floor panel manufactured in accordance with one exemplary embodiment;

FIGS. 12a to 12d illustrate a doorframe manufactured in accordance with one exemplary embodiment;

FIG. 13 is a diagram showing the mechanical characteristics of tensile strength;

FIG. 14 is a diagram showing the bending angle of a body component;

FIG. 15 is a diagram showing the results for a component made of steel; and,

FIG. 16 is a diagram showing the results for a component made of steel.

In the Figures, the same reference signs are used for identical or similar components, even if a repeated description is omitted for reasons of simplicity.

### DETAILED DESCRIPTION OF SOME EMBODIMENTS

Some embodiments will be now described with reference to the Figures.

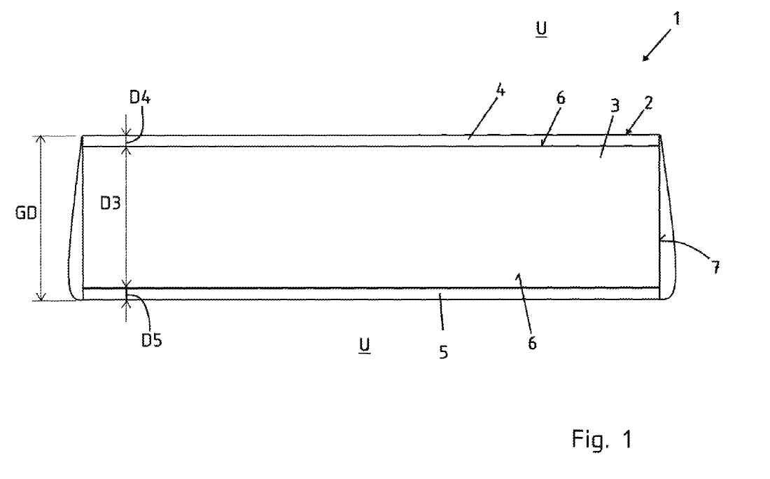

Referring to FIG. 1, a schematic cross section through a motor vehicle component 1 manufactured from a triple-layer laminated steel 2 is illustrated. For this purpose, a central layer 3 is made of a hardenable steel alloy. Two external layers 4, 5 are furthermore formed. The external layers 4, 5 are made of a stainless or rust-resistant steel alloy, in particular high-grade steel alloy. The surfaces 6 of the central layer 3 are thus shut off from the environment U by the external layers 4, 5, which are in contact over an extended area. A rim 7 running around the outside of the central layer 3 has a rim coating 8 or rim sealing. This rim coating 8 or rim sealing can be applied by a method such as thermal spraying. However, it is also possible for at least one external layer 4, 5 to be laid around the rim 7. This ensures that the rim 7 running around the central layer 3 is also shut off from the environment U. In the schematic illustration in FIG. 1, the motor vehicle component 1 has a uniform total thickness GD. The total thickness GD is made up of the thickness D4 of one external layer 4, added to the thickness D3 of the central layer 3 and the thickness D5 of the second external layer 5.

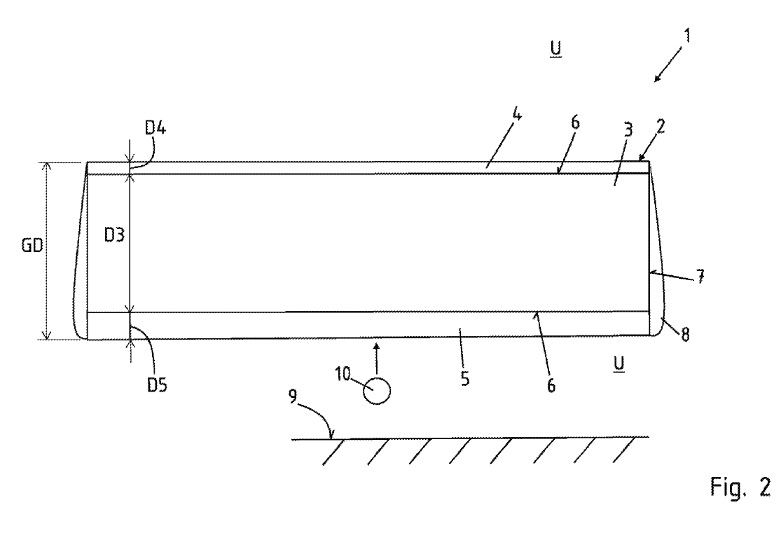

FIG. 2 shows a modified variant embodiment, wherein a lower external layer 5 in relation to the plane of the drawing is designed as an outer external layer. The upper external layer 4 in relation to the plane of the drawing is designed as an inner external layer. The outer external layer 5 is arranged facing a road surface 9 in the installed state. A stone 10 impinging on the outer external layer 5, caused by stone chips for example, should just fail to penetrate the outer external layer 5 by virtue of the greater thickness D5 of the layer. The underlying surface 6 of the central layer 3 is thus shut off from the environment U and thus protected from corrosion, even after years or decades of use of a motor vehicle. For this purpose, the outer external layer 5 is at least more than 1.3 times, preferably more than 1.5 times, very particularly more than 2 times and, in particular, more than 2.5 times as thick as the inner external layer 4.

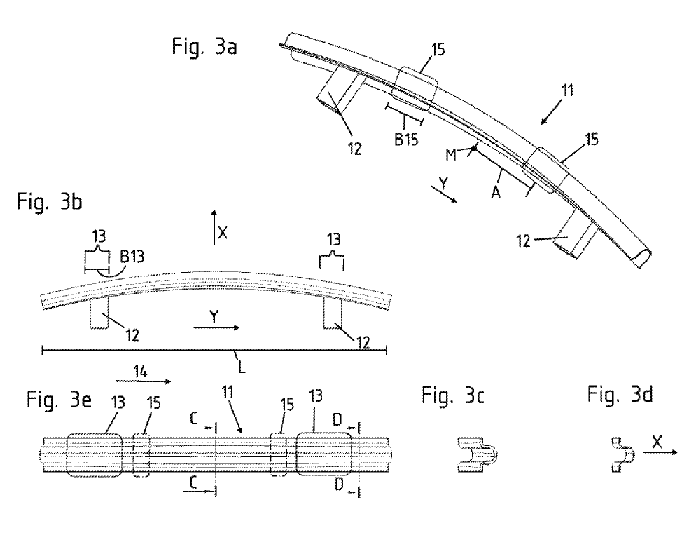

FIG. 3 shows a motor vehicle component according to the invention designed as a bumper bar or crossmember 11 in various views. FIGS. 3a, 3b, and 3e show three different views of the crossmember 11, which is designed as a motor vehicle component according to the invention. The crossmember 11 is coupled to a motor vehicle body (not shown specifically) by means of crash boxes 12. To the end of the respective longitudinal member, for example. As illustrated in FIG. 3a and the sectional views in FIG. 3c and FIG. 3d along section line C-C and D-D, the crossmember 11 has a hat-shaped profile in cross section. The profile is designed so as to be open counter to the motor vehicle longitudinal direction X. However, it is also possible for the hat-shaped profile to be designed so as to be open in the motor vehicle longitudinal direction X.

Here, an attachment region 13 of the crash box 12 is preferably designed with a softer material microstructure and/or a thinner wall thickness relative to the rest of the crossmember 11. In the case of a vehicle crash, it is thus possible to avoid the crash boxes 12 being torn off.

By virtue of the fact that the remaining part of the crossmember 11, the part extending in the longitudinal direction 14, has an identical wall thickness in cross section and/or an identical strength, sufficient rigidity with respect to deformation or bending in the case of an impact is provided.

As an alternative, a region which is in each case offset inward in the longitudinal direction 14 from the attachment regions 13 is formed as a deformation region 15, in particular as a predetermined deformation region. In the case of eccentric introduction of a load, this deformation region 15 leads to selective deformation in such a way that the crossmember is deformed in safe sections or the deformation is displaced into safe sections. The deformation regions 15 are preferably spaced apart, in particular spaced apart symmetrically, from a central point M. The spacing A is preferably 20% to 40% of the length L of the crossmember 11. The attachment regions 13 can also be combined with the deformation regions 15, with the result that these are directly adjacent to one another or partially one inside the other.

The crossmember 11 preferably has a wall thickness of 1 mm to 4 mm, in particular of 1.5 mm to 3.5 mm, particularly preferably of 1.8 mm to 2.5 mm. The crossmember is manufactured by means of hot forming and die quenching from a triple-layer laminated steel 2. However, it is also possible to use a blank which is supplied as a tailored welded blank or tailored rolled blank and is designed as laminated steel only in sections. The hardened regions preferably have a tensile strength Rm greater than or equal to 1300 MPa, while the soft regions (13, 15) have a tensile strength Rm of 500 to 900 MPa.

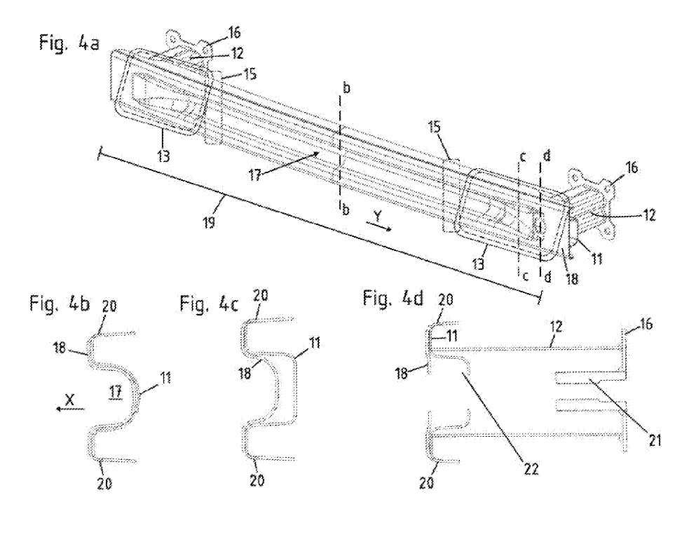

FIG. 4 likewise shows a crossmember 11 manufactured in accordance with the invention in a perspective view and in various sectional views. The crossmember 11 is coupled to crash boxes 12, which, in turn, are coupled to a flange plate 16, e.g. at the end of longitudinal members (not shown specifically) on a motor vehicle body. The crossmember 11 itself is designed as a hat-shaped profile in such a way that an opening 17 is directed forward in relation to the motor vehicle longitudinal direction X. The crossmember 11 itself is manufactured by forming from the triple-layer laminated steel. A closing plate 18 is once again coupled in front of the crossmember 11, being shown, in particular, in the sectional illustrations in FIGS. 4b, 4c and 4d. The closing plate 18 itself is likewise of hat-shaped configuration in cross section. The closing plate 18 and the crossmember 11 itself preferably rest against one another over a large part of the width 19 of the crossmember 11, in particular over more than 60%, preferably more than 70%, very particularly preferably more than 80% of the width 19. Particularly in the central region between the crash boxes 12, more than 70%, preferably more than 80%, very particularly preferably more than 90%, of the areas of the crossmember 11 and the closing plate 18 rest against one another in cross section for this purpose. This is readily visible in FIG. 4b.

The closing plate 18 and the crossmember 11 are then preferably coupled to one another by joining in a coupling region 20. As a particular preference, welding takes place here. The crossmember and the closing plate can be made of the same material. In particular, there is also the option of manufacturing the closing plate 18 from the triple-layer laminated steel. The crash box 12 too is preferably made of the laminated steel with a ferritic rust-resistant external layer.

Attachment regions 13, in which the crossmember 11 and the closing plate 18 are optionally of softer design over part of the width 19 of the crossmember 11, are furthermore formed on the crossmember 11. This can be accomplished, for example, by partial thermal after-treatment of the crossmember 11, which is initially produced by hot forming and die quenching. It is also possible to use thinner walls. A tailored rolled blank is then used as a starting material. Partial differential hot forming and/or die quenching is also possible, giving rise to softer attachment regions 13 during forming and/or die quenching. It is also possible to use a starting blank with differing wall thicknesses. For this purpose, a tailored welded blank or a tailored formed blank is preferably used.

As an alternative, it is furthermore possible for selective deformation regions 15 to be formed in the crossmember 11. The deformation regions 15 are offset inward relative to the crash boxes 12, based on the width 19 of the crossmember 11. The width 19 of the crossmember 11 is designed to be oriented largely in the motor vehicle transverse direction Y. In particular, the deformation regions 15 are designed to be softer. Once again, this can preferably be accomplished by means of partial thermal after-treatment. It is also possible for partial differential heat treatment to take place during hot forming and/or die quenching, making the deformation regions 15 selectively softer.

Also shown is an optional sleeve 21 and a through opening 22 for coupling to a towing 1 ug (not shown specifically).

Referring now to FIGS. 3 and 4, the deformation regions 15 preferably have a width B15 of 30 mm to 100 mm in the motor vehicle transverse direction Y. The attachment regions have a width B13 of 100 mm to 250 mm. Together, the two regions 13 and 15 have a width of less than or equal to 300 mm

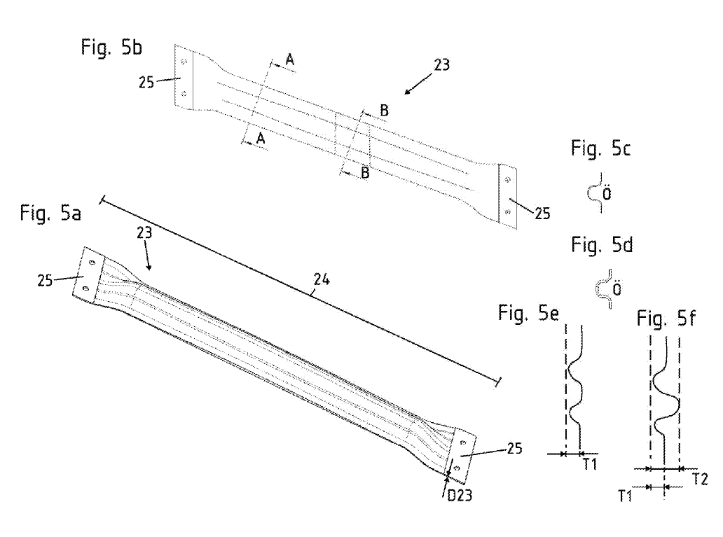

FIGS. 5a to 5d show a door impact beam 23 manufactured from a laminated steel, which has three layers according to the invention. The door impact beam 23 shown in FIG. 5a is manufactured in one piece and with a unitary material from the triple-layer laminated steel described according to the invention. Over a large part of its length 24, the door impact beam 23 has a hat-shaped profile in cross section, this being illustrated in the cross-sectional views in FIGS. 5c and 5d. The respective ends 25 are of flat design. Here, the door impact beam 23 can be mounted or coupled into a motor vehicle door frame (not shown specifically). According to FIG. 5a, the door impact beam 23 can have the same thickness D23 over its entire length 24. An opening Ö in the hat-shaped cross section faces in the direction of a passenger compartment. However, the door impact beam can also have softer or thinner regions. In particular, the ends 25 are of soft design. This can be accomplished by partial thermal after-treatment. However, a corresponding softer microstructure, in particular of the central layer of the laminated steel, can also be set in the region of the ends by partial hot forming and/or partial die quenching.

FIGS. 5e and 5f each show a double hat profile as a cross section through a door impact beam 23 in accordance with FIG. 5a. In FIG. 5e, a depth T1 is formed. Here, a double hat profile is formed, according to FIG. 5e with both corrugations in the double hat shape having the same depth. The variant embodiment shown in FIG. 5f has a greater depth T2 in a central corrugation in comparison with depth T1.

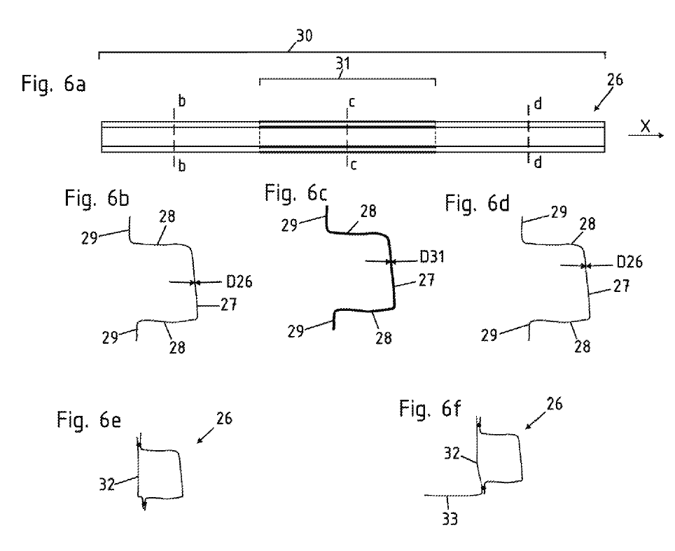

FIGS. 6a to 6d show a sill 26 manufactured in accordance with the invention. In the installed position, the sill 26 extends from an A pillar and a front wheel arch of the motor vehicle to a rear wheel arch of the motor vehicle. The sill is designed as a formed component. Referring to the cross-sectional views in FIGS. 6b to 6d, it has a hat-shaped profile in cross section. The profile is distinguished by a central web 27 with legs 28 projecting laterally from the web 27. Flanges 29 project in turn from the legs 28. The sill 26 is also made of the triple-layer laminated steel. The sill 26 has a length 30. In the installed position, its longitudinal direction is oriented in the motor vehicle longitudinal direction X. A central section 31, in the region of attachment of a B pillar for example, preferably has a greater thickness D31 than the thickness D26 of remaining sections of the sill. In particular, the central section 31 extends over 10% to 40%, preferably over 20% to 30%, of the length 30 of the sill 26. The thickness D31 is preferably more than 1.2 times, preferably more than 1.5 times, greater than the thickness D26 of the remaining sections of the sill. The differential thickness is preferably produced by a tailored rolled blank, a tailored formed blank or a tailored welded blank.

According to the illustration in FIGS. 6e and 6f, the sill 26 can also be designed as a closed hollow profile in cross section. For this purpose, a closing plate 32 is provided. The closing plate 32 itself can also be made of a triple-layer laminated steel. However, the closing plate 32 can also be manufactured from a commercially available non-heat-treatable steel. The closing plate 32 can also be made of a single-layer heat-treatable steel. According to FIG. 6f, it is furthermore possible for a closing plate 32 with an edge bend 33 to be provided, with the result that the closing plate 32 itself is of L-shaped configuration in cross section. This makes it possible for the closing plate 32 additionally to serve as a floor panel or floor panel receptacle.

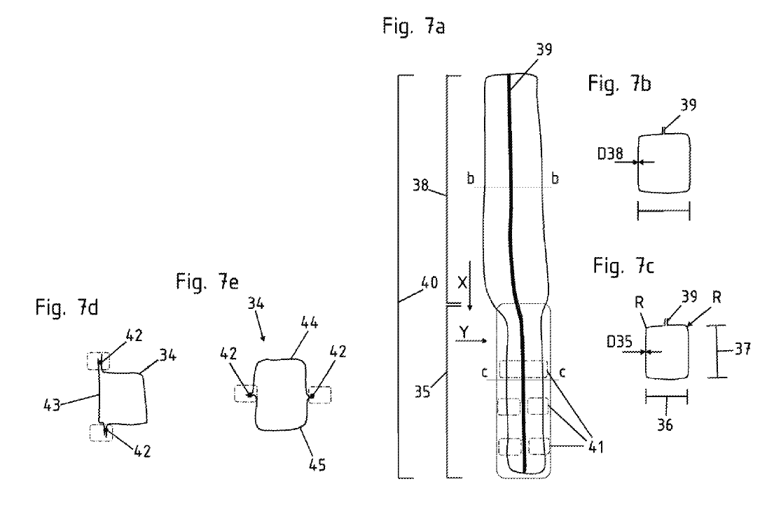

FIGS. 7a to 7c show a longitudinal member 34 in plan view and various cross-sectional views. In the installed position, the longitudinal member 34 is oriented in the motor vehicle longitudinal direction X. In particular, the longitudinal member 34 is in one piece and of unitary material and is preferably formed as a single shell from the laminated steel. Production is by means of UO forming. The different cross sections shown in FIGS. 7b and 7c are produced by supplying a specially tailored starting blank and press forming. After press forming to give the hollow cross section, hardening is carried out. Thus, the longitudinal member 34 can have a smaller width 36 and/or lower height 37 in a front section 35 than a width 38 and/or height 37 in the rear section 38. The longitudinal member 34 preferably has a projecting flange 39. This can either be welded so as to be leak-tight or, alternatively, can merely be held pressed together so as to be fluid-tight during hydroforming. At least spot welds are preferably provided.

In particular, the longitudinal member 34 has a thickness greater than 2 mm. The thickness is preferably between 2 mm and 6 mm. In a front section, the thickness D35 can be made the same as the thickness D38 of the rear section 38. However, the thickness D35 in the front section 35 can also be made less than the thickness D38 in the rear section 38. As an optional or supplementary measure, the material, in particular the central layer of the triple-layer laminated steel, can be made softer in the front region 35 than in the rear section 38. In particular, the front section 35 extends over 10% to 50%, preferably 20% to 40%, of the length 40 of the longitudinal member 34. As an optional supplementary or alternative measure, individual trigger sections 41 can be provided in the front section 35, these extending over the entire width 36 or, alternatively, only partially over part of the width 36 and/or of the height 37, for example. The trigger sections 42 also extend around the radius regions R. In particular, these trigger sections 41 are made with a softer material microstructure in the central layer.

FIGS. 7d and 7e show alternative variant embodiments in cross section. According to these, the longitudinal member 34 is of two-shell design. According to FIG. 7d, the longitudinal member 34 has a closing plate 43, which is coupled to the longitudinal member 34 in coupling sections 42. In particular, the coupling sections 42 are made softer. Tearing open or off, in particular cracking, in the case of a vehicle crash is thereby avoided. In the variant embodiments shown in FIGS. 7d and 7e, the longitudinal member 34 or the upper and lower shell 44, 45 are hot-formed and die quenched. Soft regions can be produced by a partial thermal after-treatment, for example. As an alternative or supplementary measure, it is also possible for partial tempering during hot forming and/or partial die quenching during die quenching to be produced, making the material microstructure in these trigger sections 41 correspondingly softer relative to the material microstructure of the remainder of the longitudinal member 34. It is also possible for only the longitudinal member 34 or the lower shell 45 to be hot-formed and die quenched.

FIG. 7e shows another variant embodiment of the longitudinal member 34 in cross section. Here, the longitudinal member 34 is of two-shell design, having an upper shell 44 and a lower shell 45. Here too, a correspondingly softer material microstructure is formed in coupling sections 42. As a result, coupling, e.g. by welding, does not lead to cracking in the case of a vehicle crash. The variant embodiments shown in FIGS. 7d and 7e can likewise have a front section and a rear section as well as the trigger sections 41.

In particular, the orientation of the member sections 41 is in the motor vehicle transverse direction Y. In the event of a frontal crash, a folding process or compression process of the longitudinal member in the manner of a harmonica is initiated and promoted.

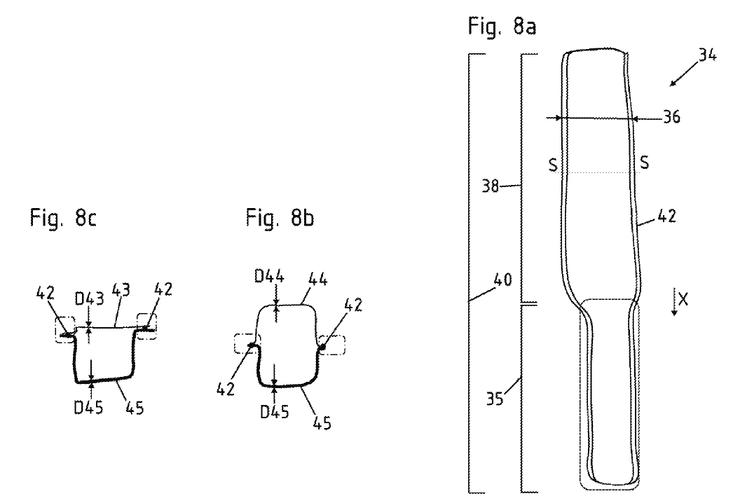

FIGS. 8a to 8c show various variant embodiments of an alternative longitudinal member 34. FIG. 8a shows a plan view of the longitudinal member 34. This likewise has a length 40 as well as a front section 35 and a rear section 38. The rear section 38 has a greater width than the front section 35. There is once again preferably a lower strength in the front section. This can be achieved by a softer material microstructure and/or a smaller wall thickness or thickness. In particular, the entire front section 35 is made softer in this case than the rear section 38.

Particularly in cross section, the longitudinal member 34 is in this case too designed as a hollow profile, as shown in the cross-sectional views S-S. In FIG. 8b, it is designed as a two-shell component, having an upper shell 44 and a lower shell 45. They are connected in the coupling section 42, e.g. by means of spot welds, once again having a softer material microstructure. The thickness D45 of the lower shell 45 is made greater than the thickness D44 of the upper shell 44. The upper shell 44 preferably has a thickness D44 less than or equal to 1.5 mm, in particular 0.8 mm to 1.0 mm. The thickness of the lower shell 45 is correspondingly greater, preferably 1.0 mm to 1.5 mm.

The thickness of the lower shell 45 is preferably more than 1.2, in particular more than 1.5, times greater than the thickness of the upper shell 44. The overall longitudinal member 34, that is to say the upper shell 44 and the lower shell 45, is preferably made of a corresponding triple-layer laminated steel.

The variant embodiment shown in FIG. 8c shows a cross-sectional view along section line S-S in FIG. 8a. Here, the longitudinal member 4 is formed exclusively by a lower shell 45. This is coupled to a closing plate 43. Here too, a softer material microstructure is formed in the coupling sections 42. Spot welds are provided, for example. In the case of a crash, there is no tearing or tearing off between the lower shell 45 and the closing plate 43. The thickness D45 of the lower shell 45 is made greater than the thickness D43 of the closing plate 43.

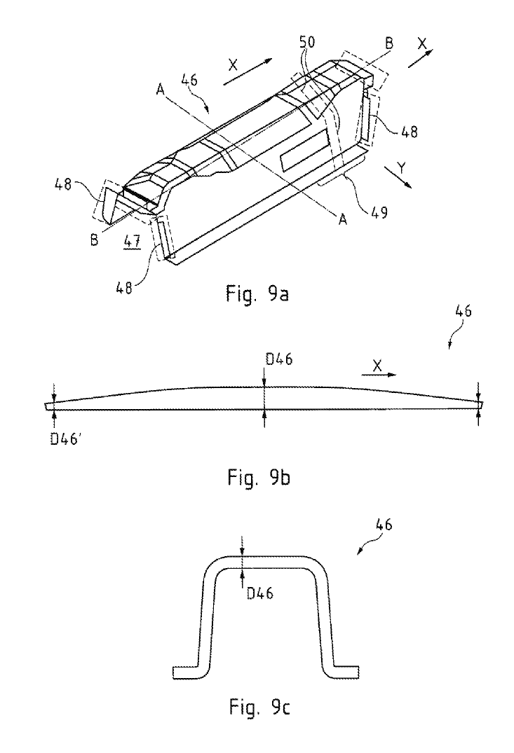

FIGS. 9a to 9c show a tunnel 46 manufactured in accordance with the invention. The tunnel 46 is designed as a transmission tunnel. FIG. 9b shows a longitudinal section along section line B-B and FIG. 9c shows a cross section along section line A-A through the tunnel 46. The tunnel 46 preferably has different thicknesses D46, D46′. In this case, thickness D46 is formed in a section in the center relative to the motor vehicle longitudinal direction X and extends uniformly over the cross section. Toward the ends 47 of the tunnel 46, thickness D46 decreases to thickness D46′. This once again preferably extends uniformly over the cross section there. Flanges 48 are arranged at the front end 47 and the rear end 47, e.g. at the front end 47 for coupling to a bulkhead or firewall (not shown specifically). The flanges 48 are preferably formed with a smaller thickness and/or a softer material microstructure. In the case of a vehicle crash, tearing off or cracking does not occur at the flanges 48. Furthermore, it is envisaged that deformation strips 50 are formed in a front longitudinal section 49 of the tunnel, this being in the motor vehicle transverse direction Y, that is to say transversely to the motor vehicle longitudinal direction X. The deformation strips 50 are preferably formed by partial thermal after-treatment, partial hot forming, partial die quenching and/or a smaller thickness and represent an alternative to a reduced thickness D46 before the end 47. Here too, the sheet metal blank for the manufacture of the tunnel 46 can be designed as a tailored rolled blank, as a tailored formed blank or a tailored welded blank.

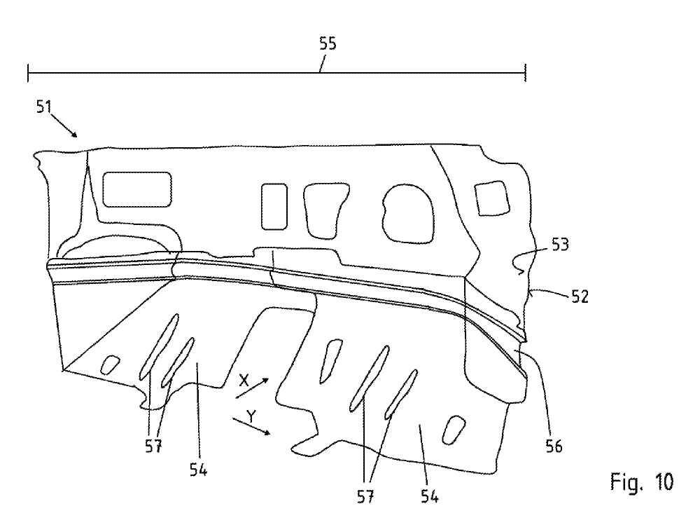

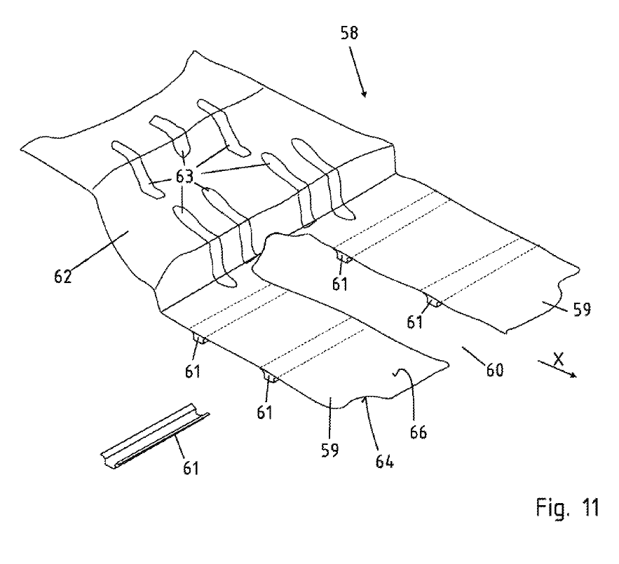

FIG. 10 shows a bulkhead 51 of a motor vehicle body. The bulkhead can also be referred to as a firewall. An outward-facing outer side 52 faces in the direction of the engine compartment (not shown specifically). An inward-facing inner side 53 faces a passenger compartment (not shown specifically). The bulkhead 51 is preferably formed integrally and with a unitary material from the triple-layer laminated steel. The external layer of the laminated steel, which faces the outer side 52, furthermore preferably has a greater thickness than the inner external layer. Better protection against stone chips is thus provided.

However, it is also conceivable for the bulkhead 51 to be made of a plurality of individual panels, to be designed as a tailored welded blank or, alternatively, as a subassembly, so that first of all a plurality of individual panels is manufactured and these are then coupled to one another to give the bulkhead 51. Particularly footplates 54 arranged in the lower region are manufactured by means of hot forming and die quenching. The entire bulkhead 51 and/or all the components required to manufacture a bulkhead 51 is/are preferably manufactured in corresponding fashion by hot forming and die quenching. However, at least the footplates 54 are made of the triple-layer laminated steel. A transverse bead 56 is formed over the entire width 55 of the bulkhead 51. This transverse bead 56 improves stiffness in the case of a side impact. As an option, the transverse bead 56 serves to receive an additional crossmember. Longitudinal beads 57 are incorporated into the footplates 54. These longitudinal beads 57 improve resistance in the case of a crash and/or against bending. Particularly resistance to penetration and overall stiffness are improved by the abovementioned beads 56, 57. Above the transverse bead 56, the bulkhead 51 can also be made of a single-layer steel sheet since this is less subject to corrosion. The transverse bead 56 too can optionally be connected to a footplate 54 as a tailored welded blank.

The bulkhead is preferably designed with a thickness of 0.8 mm to 2.0 mm.

FIG. 11 shows a floor panel 58 according to the invention. The floor panel 58 is likewise manufactured from triple-layer laminated steel. The floor panel 58 is likewise of one-piece and materially unitary design. However, the floor panel 58 can also be manufactured from individual parts which are first of all formed and then coupled to one another. Particularly in the case of a multi-part floor panel 58, all the parts of the floor panel 58 are manufactured by hot forming and die quenching. The floor panel 58 has two front seat sections 59. Formed between the seat sections is an aperture 60, in which a transmission tunnel (not shown specifically) is arranged. Arranged underneath the seat panels 59 are individual crossmembers 61, which, in particular, improve the transverse rigidity of the passenger compartment, especially in an impact taking the form of a side crash (pole test). Higher stiffness in bending is furthermore provided by virtue of the crossmembers 61. The crossmembers 61 are also preferably made of the triple-layer laminated steel.

A rear back section 62 of the floor panel 58 is provided to receive a rear bench seat and/or as a floor of a trunk. This preferably has longitudinal beads 63, which are formed in a manner oriented in the motor vehicle longitudinal direction X. Here too, the longitudinal beads 63 bring about higher stiffness in bending and better stiffness behavior precisely in the event of a rear collision. An outer side 64 is oriented to face a road surface 65. A thicker external layer of the triple-layer laminated steel than the external layer on an inner side 66 is preferably formed on the outer side 64. Thus, better protection against stone chips is provided on the outer side 64. Here too, individual regions or sections can be provided selectively with a required stiffness or different wall thicknesses or thicknesses by using tailored rolled blanks, tailored welded blanks, in particular in the back section of the floor panel.

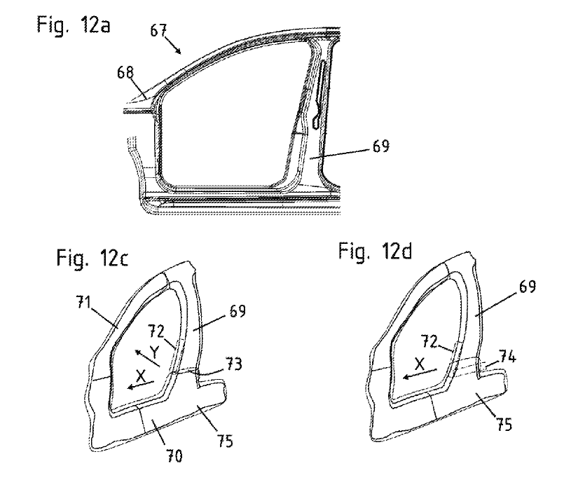

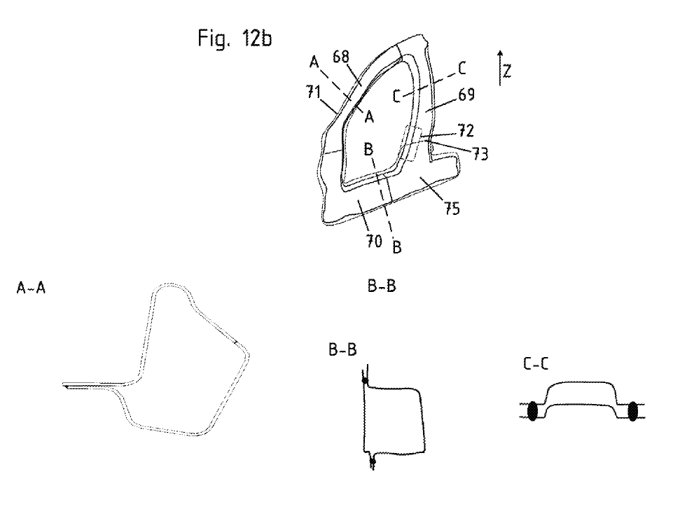

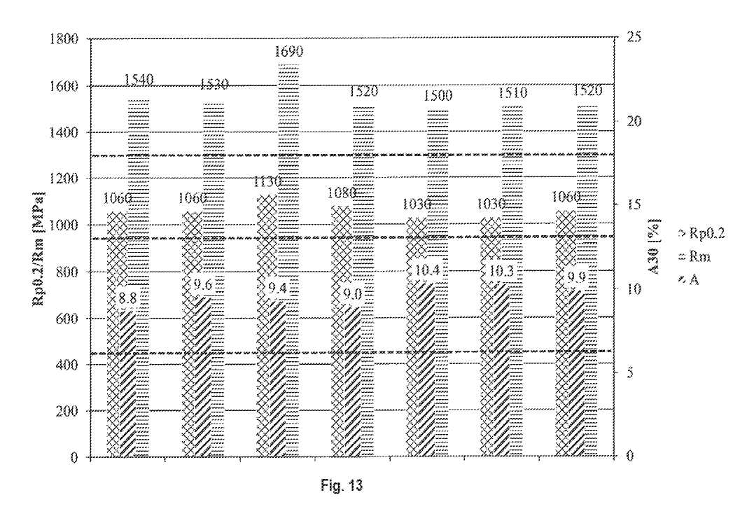

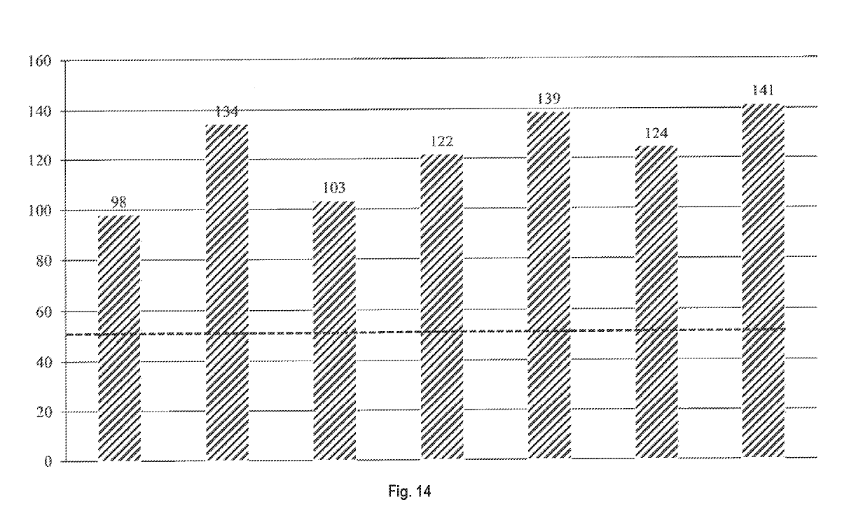

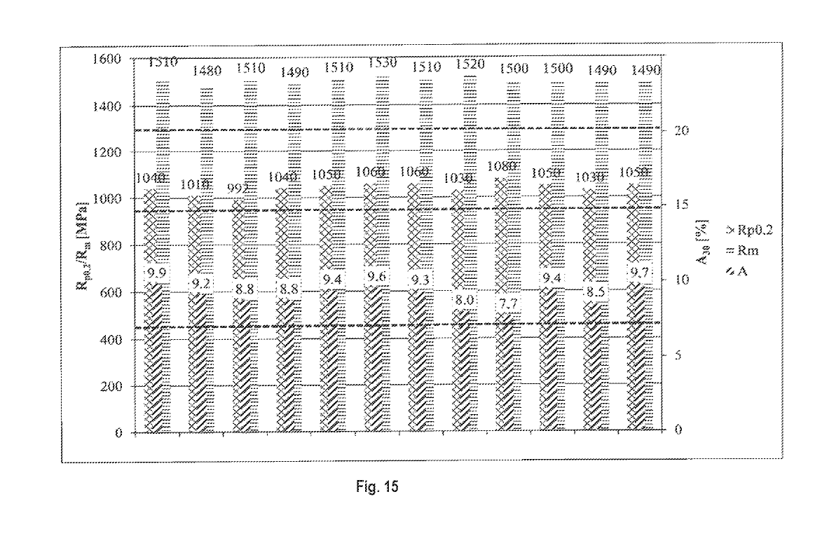

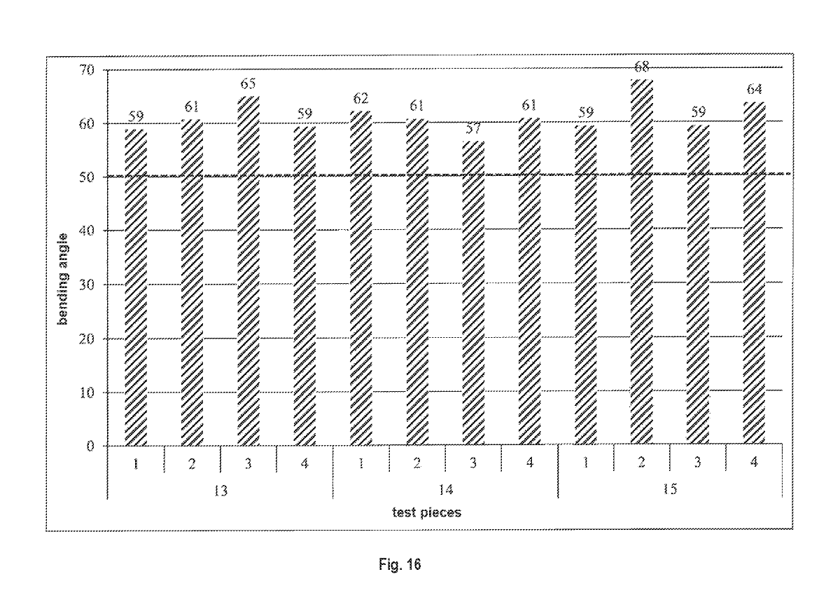

FIGS. 12a to 12d show a doorframe 67, which is part of a side wall of a motor vehicle body. The doorframe 67 can also be referred to as a door ring. In particular, the doorframe 67 has the front part of an A pillar 68, a B pillar 69 in the rear part, and a sill 70 in the lower part. The entire doorframe 67 can be made in one piece and with a unitary material from the triple-layer laminated steel. However, it is also possible for individual sheet metal blanks to be coupled to one another and formed to give the doorframe 67, wherein a triple-layer laminated steel is used in the case of at least one sheet metal blank. In particular, the doorframe 67 can be manufactured by a direct hot forming and die quenching process. The doorframe 67 is preferably used as a structural outer skin component in the motor vehicle body. It is arranged in the partially visible region. Consequently, it is temporarily covered only by the closed door (not shown). It is possible to dispense with a separate outer skin component surrounding the entire door.

The doorframe in accordance with the illustrative embodiments in FIGS. 12b, 12c, and 12d preferably has differing strength regions. In particular, a hatched region, which relates, in particular, to the A pillar 68 and the sill 70, is designed as a weaker and/or thinner region. Here, the part of the B pillar 69 is designed as a thicker region, especially in relation to the weaker region, the B pillar 69 thus ensuring sufficient stability in the case of a rollover and/or a side crash. The soft region is formed by a smaller thickness and/or lower strength properties of the material. For this purpose, a further ductile region 72 is formed in the region of the lock attachment of a door. The further ductile region 72 is made correspondingly softer by heat treatment, e.g. a partial thermal after-treatment. The weakened region ensures that a lock attachment does not tear off in the case of a crash.

Cross-sectional views relating to section lines A-A, B-B and C-C are correspondingly also shown in FIG. 12b. Overall, the doorframe is of hollow design. In this case, an outer section and an inner section are shown with a cavity situated therein.

FIG. 12c shows a variant embodiment that is an alternative thereto. Here, a weld seam is formed or a transition from a soft to a hard region is formed in the region of reference sign 73. A softer material microstructure or thinner starting material is formed in the region of the foot region 75. Here, a correspondingly softer material microstructure can be set by partial hot forming, partial die quenching or, alternatively, partial thermal after-treatment. The B pillar in the region of reference sign 69 itself, i.e. above the weld seam 75 or above the transition, is then in turn of harder design. The remaining upper region of the B pillar 69 is formed with a higher strength and/or greater thickness than the rest of the material microstructure, with the result that, here too, there is sufficient scope for protection in the case of a rollover or side crash. The region of the sill 70 and of the A pillar 71 are preferably formed with a softer material microstructure or a smaller thickness.

FIG. 12d shows another variant embodiment of the doorframe 67 manufactured in accordance with the invention. Here, a longitudinal strip 74 extending in the motor vehicle longitudinal direction X in the lower region of the B pillar 69 is formed with a softer material microstructure. In all the variant embodiments, the further ductile region 72 is likewise formed in the region for receiving a door lock. In all the variant embodiments, the foot region of the B pillar can furthermore be particularly ductile and/or unhardened. It is also possible to use a non-heat-treatable material here.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1-11. (canceled)

12. A motor vehicle component, comprising:
a central layer made of hardenable steel alloy;
a plurality of external layers made of stainless steel alloy;
wherein the motor vehicle component is manufactured by hot forming and die quenching a metallic blank made of a hardenable steel alloy; and,
wherein the motor vehicle component is made of a triple-layer laminated steel.

13. The motor vehicle component as claimed in claim 12, wherein the component is a rocker panel, a crossmember, a door impact beam, a doorframe of a side wall, a tunnel, a longitudinal member, a bulkhead, a floor panel, or a motor vehicle pillar.

14. The motor vehicle component as claimed in claim 13, wherein the motor vehicle component, at least in some sections, as a closed hollow profile in cross section, with cross sections that differ from one another in the longitudinal direction.

15. The motor vehicle component as claimed claim 14, wherein the closed hollow profile is formed by U-O forming and/or in that the hollow profile is formed by hydroforming with cross sections that differ from one another in the longitudinal direction.

16. The motor vehicle component as claimed in claim 14, further comprising a closing plate, wherein the closing plate is formed from the triple-layer laminated steel or is made from a material different from the triple-layer laminated steel.

17. The motor vehicle component claim 15, wherein the blank is manufactured as a tailored rolled blank, tailored formed blank or tailored welded blank, with the result that the motor vehicle component has different thicknesses in different regions.

18. The motor vehicle component as claimed in claim 17, wherein the external layers have different thicknesses from one another.

19. The motor vehicle component as claimed in claim 12, wherein the motor vehicle component has at least one weakened region.

20. The motor vehicle component as claimed in claim 19, wherein the weakened region is formed by a smaller thickness and/or lower strength of the material microstructure of the central layer.

21. The motor vehicle component as claimed in claim 12, wherein the motor vehicle component is subjected to thermal after-treatment.

22. The motor vehicle component as claimed in claim 12, wherein the central layer has a tensile strength Rm greater than 1400 MPa.

23. The motor vehicle component as claimed in claim 12, wherein the motor vehicle component is made of a high-grade stainless steel alloy.

24. The motor vehicle component as claimed in claim 12, wherein the central layer has a tensile strength Rm great than 1700 MPa.
